(19) United States
(12) Patent Application Publication
(10) Pub. No.: US 2009/0087172 A1
(43) Pub. Date: Apr. 2, 2009

(54) FOCAL POINT DETECTION DEVICE AND IMAGE CAPTURE DEVICE

(75) Inventors: Michitaka NAKAZAWA, Miyagi (JP); Akihiro Maejima, Saitama (JP); Shigeru Ichikawa, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/211,534

(22) Filed: Sep. 16, 2008

(30) Foreign Application Priority Data
Sep. 19, 2007 (JP) 2007-242791

(51) Int. Cl. G03B 17/00; G03B 13/36

(52) U.S. Cl. 396/55; 396/104

(57) ABSTRACT

A focal point detection device capable of good focal position detection even when the focus lens is displaced due to impact, and an image capture device. During focal point detection, when focal point detection is impossible, whether AF evaluation values decrease continuously is determined, and whether impact has occurred is detected when decreasing continuously. The focus lens is moved to the initial position when AF evaluation values decrease continuously and impact is detected, as the focus lens is possibly displaced. After the focal point detection is performed again and it is determined whether it is possible to detect the focal point, the focus lens is moved to the focal position when focal point detection is possible, and the focus lens is moved toward the nearside when focal point detection is not possible, on the basis that the photographic subject has been image captured outside of the set image capture range.

### CROSS-REFERENCE TO RELATED APPLICATION

This application claims priority under 35 USC 119 from Japanese Patent Application No. 2007-242791, the disclosure of which is incorporated by reference herein.

### BACKGROUND OF THE INVENTION

1. Field of the Invention

The present invention relates to a focal point detection device and to an image capture device, and in particular to a focal point detection device that carries out automatic focal point detection and is installed in an image capture device such as a camera, and such an image capture device.

2. Description of the Related Art

Various devices have been proposed which incorporate “autofocus” functions for automatically detecting the focal position of the lens of an image capture device such as a camera. Technology has, for example, been disclosed in Japanese Patent Application Laid-Open (JP-A) No. 1-187516 for driving the lens to the initial rest position when determination is made that focusing is not possible.

A technology is also disclosed in Japanese Patent Application Laid-Open (JP-A) No. 1-260426 of detecting, in a camera that has a focal point adjustment mechanism controlled by a stepping motor, a state in which the focal point adjustment mechanism has not been set to the initial position, such as when the battery is removed from the camera in mid-operation of the stepping motor and remains in that position, and the focal point adjustment mechanism being then set to the initial position.

A technology is also disclosed in Japanese Patent Application Laid-Open (JP-A) No. 2001-83398 of detecting the occurrence or not of an impact when the stepping motor for driving a stepping motor is stopped, and when an impact occurs, an excitation current is applied to obtain a stabilizing torque capable of withstanding such an impact, preventing the lenses being moved by the impact.

Recently, in order to limit the thickness of the body of digital cameras, bent light optical systems are also being adopted with the light incident from a photographic subject bent at a right angle by a prism or the like, and introduced through the zoom lens and the focus lens to be incident on the image capture element.

The zoon lens and focus lens in such a structure are mounted to a lens frame attached to a carriage, and the carriage is attached to a leadscrew having its length along the up-down direction (direction of gravity). When the leadscrew rotates, this rotation is converted into linear movement in the up-down direction of the carriage, and the focus lens and zoom lens move up or down accompanying the carriage movement.

However, when such a bent optical system is adopted, if an impact occurs during image capture, position of the carriage may be displaced downward (jumping teeth) due to the weight of the focus lens itself, resulting in the focal position not being possible to detect, namely, being outside of the detection range of focal position.

### SUMMARY OF THE INVENTION

The present invention is proposed to address the above issues, and provides a focal point detection device with good focal position detection even when the focus lens has been displaced due to an impact, together with an image capture device of the same.

To address the above issues, a first aspect of the present invention is a focal point detection device having: an optical system including an focus lens for focusing a photographic subject image at a image forming position; a drive unit that drives the focus lens along an optical axis direction; a computing unit that computes a focus control evaluation value for detecting a focal position; and a controller that controls the computing unit to compute the focus control evaluation value while moving the focus lens in a predetermined focal point detection range, and controls the drive unit so as to move the focus lens to a predetermined initial position when the computed focus control evaluation value in the focal point detection range decreases continuously.

According to this aspect of the present invention, when the focus control evaluation values in the focal point detection range decrease continuously or simply decrease (tails off without any significant rise in value), namely when the focus lens has become displaced due to an impact, the focal position thereafter can be appropriately detected by moving the focus lens to the predetermined initial position.

According to a second aspect of the present invention, the focal point detection device further includes an impact detection sensor, wherein the controller controls the drive unit so as to move the focus lens to the initial position when both the focus control evaluation value in the focal point detection range decreases continuously and an impact has been detected by the impact detection sensor.

By adding the additional factor of an impact having been detected by the impact sensor to the conditions for determining displacement of the focus lens due to impact in this manner, precision detection of focus lens displacement can be made.

According to a third aspect of the present invention, the impact detection sensor is an angular velocity sensor used for camera shake correction, and determination in which an impact is applied is made when an output value from the angular velocity sensor is a predetermined value or greater.

The cost of a device may be suppressed by using a common sensor for the impact detection sensor and for the camera shake correction angular velocity sensor.

According to a fourth aspect of the present invention, the optical system is a bent optical system in which light incident from a photographic subject is bent at a specific angle and guided to the focus lens.

The present invention has a particularly significant effect when applied to such a bent optical system, since displacement readily occurs of the focus lens due to an impact by the focus lens moving in the direction of gravity.

According to a fifth aspect of the present invention, the controller controls the drive unit so as to move the focus lens to the predetermined initial position when the computed focus control evaluation value in the focal point detection range decreases continuously from a near side to an infinity side.

According to a sixth aspect of the present invention, the controller controls the drive unit so as to move the focus lens to the predetermined initial position when the computed focus control evaluation value in the focal point detection range decreases continuously, and thereafter, the controller again controls the computing unit to compute the focus control evaluation value while moving the focus lens in the predetermined focal point detection range.

A seventh aspect of the present invention is an image capture device configured with any one of the focal point detection devices of the first to the sixth aspects, According to this aspect, when the focus control evaluation values of the focal point detection range decrease continuously, namely when the focus lens has become displaced due to an impact, the focal position thereafter can be appropriately detected after moving the focus lens to the predetermined initial position, and good image capture of in-focus photographic subjects is possible.

An effect may be achieved according to the present invention of good focal position detection even when the focus lens has been displaced by an impact.

### BRIEF DESCRIPTION OF THE SEVERAL VIEWS OF THE DRAWINGS

Embodiments of the present invention will be described in detail based on the following figures, wherein:

FIG. 1 is a front view of a digital camera;

FIG. 2A is a side view of an optical system unit and FIG. 2B is a front view of an optical system unit;

FIG. 3 is a block diagram showing a schematic configuration of an electrical system of a digital camera;

FIG. 4 is a flow chart of focal point detection processing;

FIGS. 5A, 5B and 5C are graphs showing the wave shapes of AF evaluation values; and

FIG. 6 is a flow chart of impact detection processing.

### DETAILED DESCRIPTION OF THE INVENTION

Explanation is given below of details of the preferable mode of working the present invention, with reference to the figures.

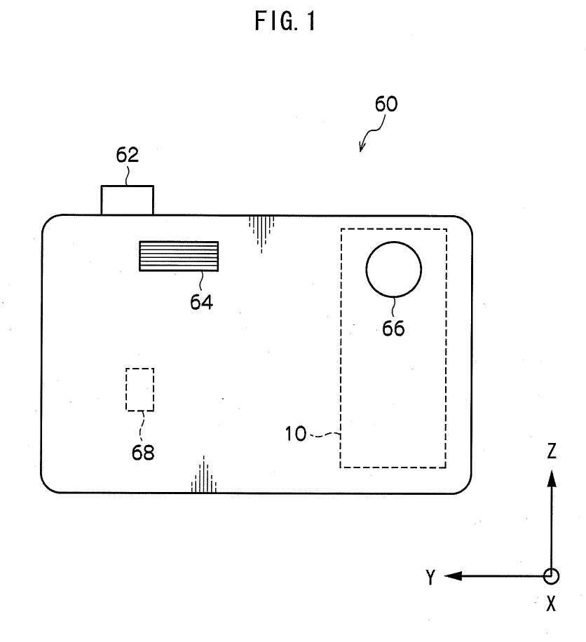

A front view of a digital camera 60 according to the present invention is shown in FIG. 1. Disposed on the top and front faces of the digital camera 60 are a shutter button 62 for instructing image capture, a flash unit 64 for carrying out flash exposure to a photographic subject, and a lens aperture portion 66 through which light from the photographic subject is incident. An angular velocity sensor 68 that detects camera shake for carrying out correction therefor, an optical system unit 10 accommodating a zoom lens, a focus lens etc., and also electrical circuits and the like are built into the digital camera 60.

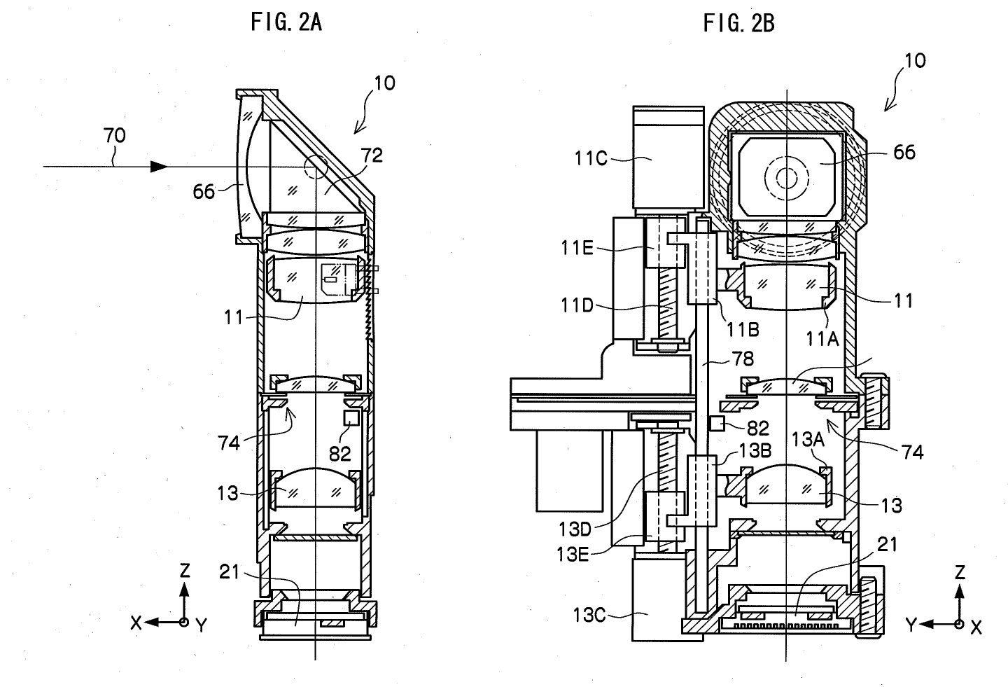

Details of the configuration of the optical system unit 10 are shown in FIGS. 2A and 2B, with FIG. 2A being a side view of the optical system unit 10 and FIG. 2B being a front view.

As shown in FIG. 2A, the optical system unit 10 uses a “bent optical system”, with an incident light beam (bundle) 70 passing through the lens aperture portion 66, then being bent at a prism 72 through substantially a right angle into a downward direction (the direction of gravity when the digital camera 60 is held in the normal manner). The depth (size in the focal point direction) can thereby be made smaller, and a thin body can be realized.

The incident light beam 70 that has been bent then passes through various lenses, such as a zoom lens 11, a focus lens 13 and other lenses, and the incident light beam 70 is then imaged (image-formed) as a image of image capture on a CCD 21 serving as an image capture element. A photographer operates a shutter 74 by depressing a shutter button 62, and image exposure is carried out on the CCD 21.

The zoom lens 11, as shown in FIG. 2B, is held by a zoom lens frame 11A, and the zoom lens frame 11A is fixed to (formed integrally manner) a lens frame guide 11B that is supported so as to be able to slide on a support pillar 78. The lens frame guide 11B fits over a carriage 11E that is attached to a leadscrew 11D of a stepping motor 11C. The carriage 11E moves up and down in the Z direction by rotation of the leadscrew 11D. It should be noted that sometimes when there is a given degree of impact in the Z direction the carriage 11E displaces downward, namely the carriage 11E jumps teeth.

When the leadscrew 11D rotates due to rotation of the stepping motor 11C, the rotational movement of the leadscrew 11D is converted into linear movement of the lens frame guide 11B, and the lens frame guide 11B moves up and down in the Z direction of the figure.

In a similar manner, the focus lens 13 is held a focus lens frame 13A, and the focus lens frame 13A is fixed (formed integrally manner) to a lens frame guide 13B that is supported so as to be able to slide on the support pillar 78. The lens frame guide 13B fits over a carriage 13E that is attached to a leadscrew 13D of a stepping motor 13C. The carriage 13E moves up and down in the Z direction by rotation of the leadscrew 13D. It should be noted that sometimes when there is a given degree of impact in the Z direction the carriage 13E displaces downward, namely the carriage 13E jumps teeth.

When the leadscrew 13D rotates due to rotation of the stepping motor 13C, the rotational movement of the leadscrew 13D is converted into linear movement of the lens frame guide 13B, and the lens frame guide 13B moves up and down in the Z direction of the figure.

There is an initial position detection sensor 82 provided above the focus lens 13. The initial position detection sensor 82 detects when the focus lens 13 has moved to an initial position set near to the initial position detection sensor 82, and outputs a detection signal.

Whilst not shown in FIG. 2, the optical system unit 10 is configured, between the focus lens 13 and the CCD 21, an anti-vibration (vibration control) mechanism of a lens etc. for correction of camera shake is provided.

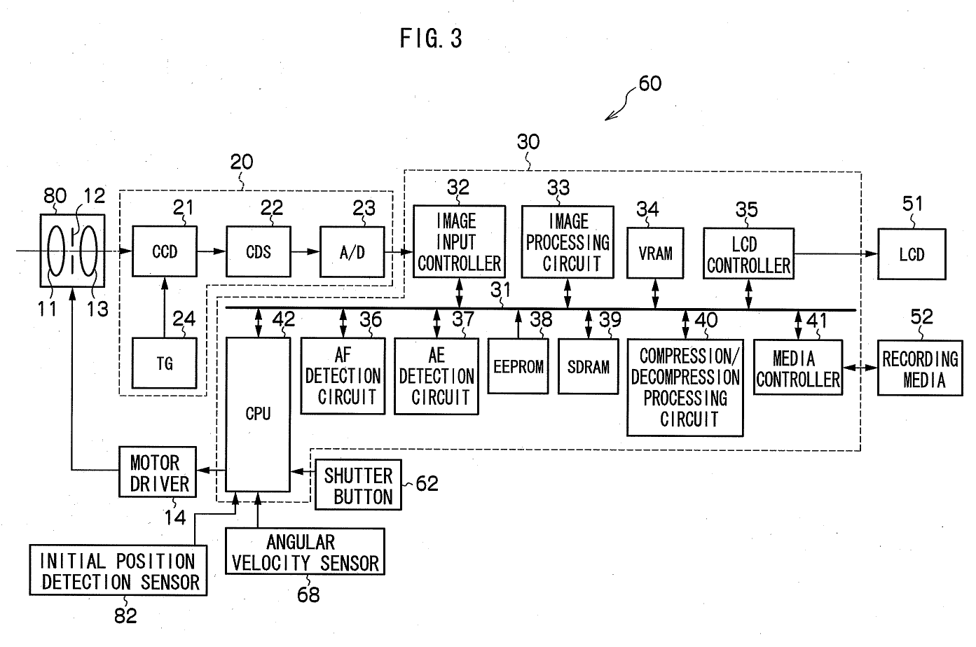

Explanation will now be given of a configuration of the electrical system of the digital camera 60. A block diagram showing a schematic configuration of the electrical system of the digital camera 60 is shown in FIG. 3.

The digital camera 60 is provided with an optical system 80 to which captured image light from the photographic subject is input, an image capture unit 20, disposed at rear side of the optical axis of the optical system 80 for image capture of the photographic subject through the optical system 80, a main controller 30 for image processing and overall control, and an output unit 50 for outputting images processed by the main controller 30.

The optical system 80 is provided with the zoom lens 11, a diaphragm mechanism 12 (not shown in FIG. 2), the focus lens 13, and a not illustrated anti-vibration mechanism and the like. The zoom lens 11 is able to move in the optical axis direction by operation of a zoom motor (stepping motor 11C) and the focus lens 13 is able to move in the optical axis direction by operation of an autofocus motor (stepping motor 13C). The diaphragm mechanism 12 is controlled by an iris motor. These motors are controlled by a motor driver 14.

The image capture unit 20 is provided with: the CCD image sensor 21 which generates an image signal of the photographic subject image according to the captured image light from the optical system 80; a CDS (Correlated Double Sampling) circuit 22 which carries out the correlated double sampling processing which removes noise components included in the image signal read out from the CCD image sensor 21; a digital/analog convertor (referred to below as A/D convertor) 23 which converts an analog signal processed by the CDS circuit 22 into a digital signal; and a timing generator (TG) 24 which generates a timing signal for driving the CCD image sensor 21.

The main controller 30 is provided with various circuits that are connected mutually through a BUS 31. To be more precise, the main controller 30 is provided with: an image input controller 32, which supplies image data from the A/D convertor 23 to the BUS 31; an image processing circuit 33, which carries out specific digital signal processing on image data that has been input thereto; a VRAM 34 for storing image data representing images to be displayed; and an LCD controller 35, which controls display the image based on image data stored in the VRAM 34 on an LCD 51.

In addition, the main controller 30 is also provided with: an AF detection circuit 36, which detects contrast value used for adjusting the focus of the focus lens 13; an AE (Auto Exposure) detection circuit 37, which detects the optimum exposure and white balance based on the image data; an EEPROM (Electrically Erasable Programmable Read Only Memory) 38, which stores in advance information such as various programs and parameters; an SDRAM (Synchronous Dynamic Random Access Memory) 39 used as a working memory; a compression/decompression circuit 40, which compresses or decompresses the image data; a media controller 41, which reads and writes various types of information on recording media 52; and a CPU 42, which reads out appropriate information from the EEPROM 38 and controls the above components.

The AF detection circuit 36 detects contrast value of image data input from the image capture unit 20 and stored in the VRAM 34. Contrast value represents the degree to which the photographic subject is at the focal point. The focal position is therefore obtained when the contrast value is greatest. In the present exemplary embodiment the contrast value is used as AF evaluation value.

The AE/AWB detection circuit 37 detects an exposure value (EV) on the basis of the image data, the EV representing the brightness of a photographic subject. The EV is used as a photometry value to obtain the diaphragm value and shutter speed.

In the image capture device configured as above, an analog signal output from the CCD image sensor 21 representing the photographic subject is processed by the CDS circuit 22, and then, after conversion into a digital signal by the A/D convertor 23, is input as image data to the main controller 30 from the image input controller 32. This input image data is temporarily stored on the SDRAM 39, through the BUS 31.

In the main controller 30, the AF detection circuit 36 computes the contrast value based on the image data stored in the SDRAM 39 and the AE detection circuit 37 performs AE computation. Based on these computation results, the CPU 42 moves the focus lens 13 to the focal position using the motor driver 14, and also sets the appropriate exposure control values (diaphragm value and shutter speed) of the aperture mechanism 12 and the CCD image sensor 21, and sets the AWB adjustment value.

In the main controller 30, a non illustrated camera shake correction lens is driven according to an output value from the angular velocity sensor 68 and camera shake correction control is performed.

It should be noted that while in the present exemplary embodiment the AE detection circuit 37 computes the brightness of the photographic subject, that is, the EV and diaphragm value etc., based on the image data, there is no limitation thereto. For example, a light sensor or the like may be provided for detecting the peripheral light amount and computation may be performed based on the output from such a light sensor.

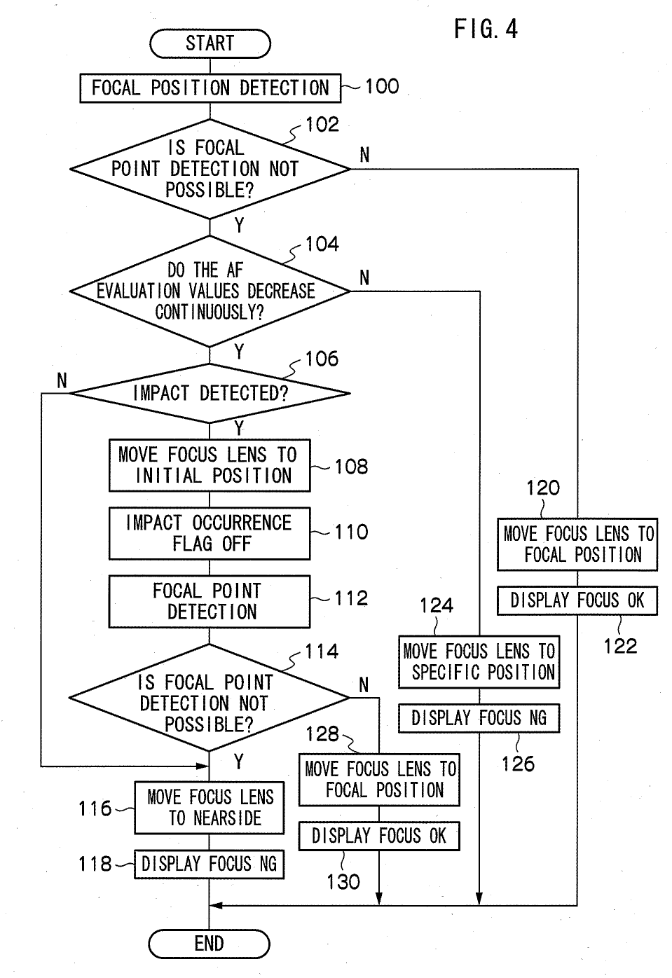

Explanation will now be given of the operation of the present exemplary embodiment, with reference to the flow chart of the focal point detection control, executed in the CPU 42, and shown in FIG. 4. The control shown in FIG. 4 is executed when the shutter button 62 is half-depressed.

First, focal point detection processing, namely autofocus processing, is executed in step 100. More specifically, the CPU 42 drives the stepping motor 13C through the motor driver 14, and, while the focus lens 13 is moved within a focal point detection range set in advance from the initial position, the position with the maximum AF evaluation value, which is the contrast value detected by the AF detection circuit 36, is detected.

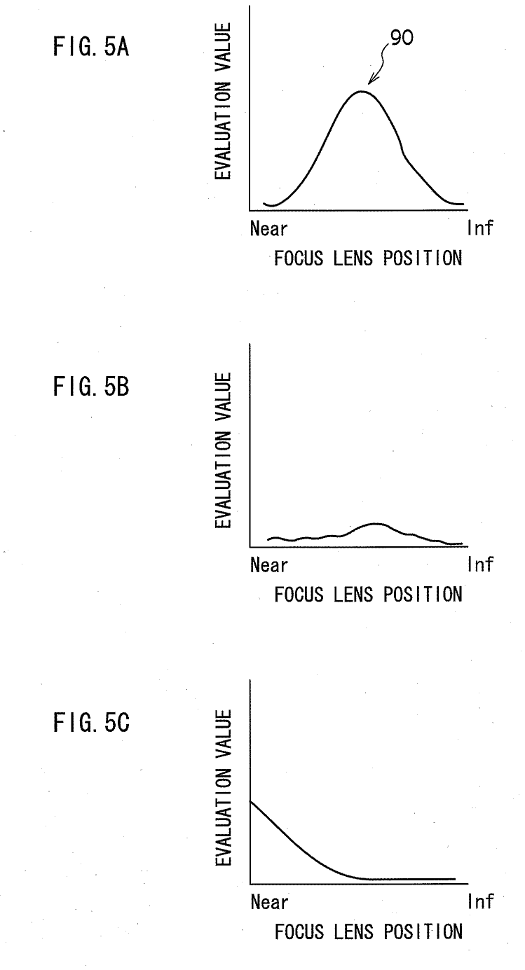

Determination is made at step 102 as to whether or not the focal point detection is not possible. For example if, as shown in FIG. 5A, there is a peak 90 in the waveform of the AF evaluation value somewhere from the Near side of the focus lens 13 (referred to below simply as nearside) and the Inf side of the focus lens 13 (referred to below as the infinity side), then the position (the peak position) is taken as the focal position. Determination at step 102 is “No” in this case, and the routine proceeds to step 120.

The stepping motor 13C is driven at step 120 such that the focus lens 13 is moved to the focal position. The routine then proceeds to step 122 and the fact that focusing has been achieved is displayed on the LCD 51, such as with a mark or a message.

However, there are occasions in which it is not possible to focus, such as when image capturing a photographic subject of low contrast or low illuminance, such as when the carriage 13E supporting the focus lens 13 is displaced downward in FIG. 2 due to jumping teeth by an impact being applied on the digital camera 60, such as when the photographic subject is too near, or such as when the photographic subject is outside of the preset image capture range.

When a photographic subject of low contrast or low illuminance is image captured, the waveform of the AF evaluation value is a shape without a strong peak such as the peak 90, as shown in FIG. 5B. In contrast, waveform of the AF evaluation value when the carriage 13E has jumped teeth or when the photographic subject is outside of the predetermined image capture range, the AF evaluation value has a waveform that decreases continuously (decreases simply) toward the infinity side from the nearside, as shown in FIG. 5C.

Therefore, determination is made in step 104 whether or not the AF evaluation value decreases continuously from the nearside to the infinity side, and the routine proceeds to step 106 when there is a continuous decrease, as there is a possibility that the carriage 13E has jumped teeth. However, when there is no continuous decrease the routine proceeds to step 124 as that a photographic subject of low contrast or low illuminance has been image captured.

At step 124, the stepping motor 13C is driven so that the focus lens 13 moves to a predetermined position, for example, an intermediate position (pseudo panfocus position) between the nearside and the infinity side. The routine then proceeds to step 126 and the fact that focusing is not possible is displayed on the LCD 51, such as by a mark or a message.

When the carriage 13E has jumped teeth the waveform of the AF evaluation value, as described above, is a waveform in which the AF evaluation value continuously decreases from the nearside to the infinity side, as shown in FIG. 5C, however, the waveform of the AF evaluation value is also a similar shape when a photographic subject outside of the preset image capture range has been image captured. Consequently it is sometimes not possible to discriminate just by reference to the waveform of the AF evaluation value between whether the reason that the AF evaluation value continuously decreases is due to the occurrence of an impact or due to the photographic subject being image captured outside of the preset image capture range.

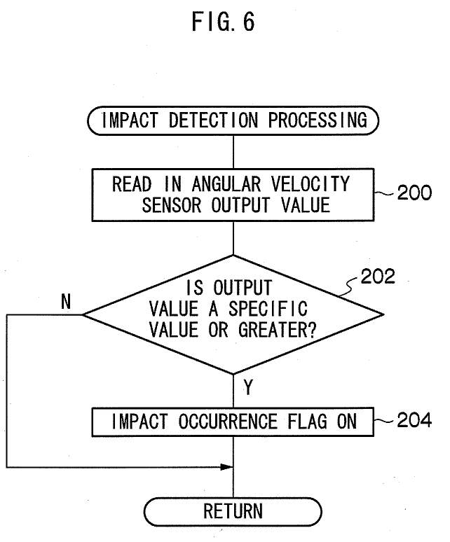

In order to address this issue, determination is made at step 106 as to whether or not there has been an impact, on the basis of an output value from the angular velocity sensor 68. An impact here means an impact in which there is a possibility that the carriage 13E has jumped teeth. Detection is made as to whether or not the digital camera 60 has been subjected to an impact on the basis of the output value from the angular velocity sensor 68. When the power for the digital camera 60 is switched on, the output value from the angular velocity sensor 68 is output to the CPU 42 every specific interval of time, and an interrupt routine is executed in the CPU 42, such as that shown in FIG. 6.

First, in step 200, the output value is read in from the angular velocity sensor 68, and determination is made at step 202 as to whether or not the read-in output value is a predetermined (specific) value or greater. This predetermined value is set as a value that allows determination of the possibility that the carriage 13E has jumped teeth when the output value from the angular velocity sensor 68 is this predetermined value or greater.

When the output value from the angular velocity sensor 68 is the predetermined value or greater the routine proceeds to step 204, namely it is considered possible that the carriage 13E has jumped teeth.

At step 204, an impact occurrence flag, indicating whether or not an impact with a possibility of the carriage 13E jumping teeth has occurred, is on and written to the SDRAM 39 served as working memory. However, when the output value from the angular velocity sensor 68 is less than the predetermined value, the routine returns on the basis that an impact with a possibility of the carriage 13E jumping teeth has not occurred.

Consequently, at step 106 of FIG. 4, determination is made as to whether or not an impact with a possibility of jumping teeth has occurred by determining whether or not the impact occurrence flag stored in the SDRAM 39 is on.

The routine proceeds to step 108, when the impact occurrence flag is on, on the basis that there is a possibility the carriage 13E has jumped teeth. However, determination is made that the photographic subject has been image captured outside of the preset image capture range when the impact occurrence flag is off, and the routine proceeds to step 116.

The focus lens 13 is moved to the initial position at step 108. Specifically the focus lens 13 is moved upward in FIG. 2, and movement of the focus lens 13 is stopped when the focus lens 13 is detected by the initial position detection sensor 82.

The impact occurrence flag is set off at step 110, and at step 112 the focal point detection processing is performed in a similar manner to at step 100.

At step 114, determination is made in a similar manner to as at step 102 as to whether or not focal point detection is not possible, and the routine proceeds to step 116 when focal point detection is not possible, and the routine proceeds to step 128 when focal point detection is possible.

When focal point detection is not possible in this case, this case is considered as a case in which: the impact occurrence flag is on, namely it is a case in which an impact in which it is possible that teeth have jumped has occurred; then, focal point detection is not possible even by carrying out focal point detection processing after moving the focus lens 13 to the initial position. Therefore, it is considered to be a case in which jumped teeth has not occurred in fact but the photographic subject has been image captured outside of the predetermined image capture range.

At step 116, the stepping motor 13C is driven so that the focus lens 13 is moved to the end portion, which at the nearside end shown in FIGS. 5A to 5C. The fact that focusing is not possible is then displayed on the LCD 51, such as with a mark or message, in a similar manner to as in step 126.

However, when the focal point has been detected, it is considered that jumped teeth has occurred in fact. The stepping motor 13C is then driven, in a similar manner to in step 120, such that the focus lens 13 is moved to the focal position. The fact that focusing has been achieved is then displayed on the LCD 51, such as with a mark or message, in a similar manner to as in step 122.

After this, image capturing of the photographic subject is executed when the shutter button 62 is depressed fully.

The present exemplary embodiment, in this manner, determines whether or not the carriage 13E supporting the focus lens 13 has jumped teeth by determining whether or not an impact has occurred both on the basis of whether or not the AF evaluation value decreases continuously to the infinity side form the nearside and also on the basis of the output value from the angular velocity sensor 68. Thereby able to appropriately detect the focal position even when the carriage 13E has jumped teeth.

It should be noted that while the present exemplary embodiment, in step 106 of FIG. 4, determines, with high accuracy, whether or not the carriage 13E has jumped teeth by determining if an impact has occurred on the basis of the output value from the angular velocity sensor 68, the determination may be made simply from whether or not the AF evaluation value decreases continuously to the infinity side from the nearside, and step 106 may be omitted.

In the present exemplary embodiment, explanation has been given of an example in which the present invention is applied to a digital camera using a bent optical system, however may be applied to a digital camera using a normal optical system rather than the bent optical system as long it is of a configuration in which there is a possibility of an occurrence of the carriage 13E jumping teeth.

In the present exemplary embodiment one example of using the contrast value of the image data as the AF evaluation value is given, however there is no limitation thereto.

In the present exemplary embodiment the angular velocity sensor 68 is used both for camera shake correction control and for impact detection, however separate sensors may be provided therefor.

What is claimed is:

1. A focal point detection device comprising:
an optical system including an focus lens for focusing a photographic subject image at a image forming position;
a drive unit that drives the focus lens along an optical axis direction;
a computing unit that computes a focus control evaluation value for detecting a focal position; and
a controller that controls the computing unit to compute the focus control evaluation value while moving the focus lens in a predetermined focal point detection range, and controls the drive unit so as to move the focus lens to a predetermined initial position when the computed focus control evaluation value in the focal point detection range decreases continuously.

2. The focal point detection device of claim 1, further comprising an impact detection sensor, wherein the controller controls the drive unit so as to move the focus lens to the initial position when both the focus control evaluation value in the focal point detection range decreases continuously and an impact has been detected by the impact detection sensor.

3. The focal point detection device of claim 2, wherein the impact detection sensor is an angular velocity sensor used for camera shake correction, and determination in which an impact is applied is made when an output value from the angular velocity sensor is a predetermined value or greater.

4. The focal point detection device of claim 1, wherein the optical system is a bent optical system in which light incident from a photographic subject is bent at a specific angle and guided to the focus lens.

5. The focal point detection device of claim 1, wherein the controller controls the drive unit so as to move the focus lens to the predetermined initial position when the computed focus control evaluation value in the focal point detection range decreases continuously from a near side to an infinity side.

6. The focal point detection device of claim 1, wherein the controller controls the drive unit so as to move the focus lens to the predetermined initial position when the computed focus control evaluation value in the focal point detection range decreases continuously, and thereafter, the controller again controls the computing unit to compute the focus control evaluation value while moving the focus lens in the predetermined focal point detection range.

7. An image capture device comprising a focal point detection device, the focal point detection device including:
an optical system including an focus lens for focusing a photographic subject image at a image forming position;
a drive unit that drives the focus lens along an optical axis direction;
a computing unit that computes a focus control evaluation value for detecting a focal position; and
a controller that controls the computing unit to compute the focus control evaluation value while moving the focus lens in a predetermined focal point detection range, and controls the drive unit so as to move the focus lens to a predetermined initial position when the computed focus control evaluation value in the focal point detection range decreases continuously.

8. The image capture device of claim 7, wherein the focal point detection device further includes an impact detection sensor, wherein the controller controls the drive unit so as to move the focus lens to the initial position when both the focus control evaluation value in the focal point detection range decreases continuously and an impact has been detected by the impact detection sensor.

9. The image capture device of claim 8, wherein the impact detection sensor is an angular velocity sensor used for camera shake correction, and determination in which an impact is applied is made when an output value from the angular velocity sensor is a predetermined value or greater.

10. The image capture device of claim 7, wherein the optical system is a bent optical system in which light incident from a photographic subject is bent at a specific angle and guided to the focus lens.

11. The image capture device of claim 7, wherein the controller controls the drive unit so as to move the focus lens to the predetermined initial position when the computed focus control evaluation value in the focal point detection range decreases continuously from a near side to an infinity side.

12. The image capture device of claim 7, wherein the controller controls the drive unit so as to move the focus lens to the predetermined initial position when the computed focus control evaluation value in the focal point detection range decreases continuously, and thereafter, the controller again controls the computing unit to compute the focus control evaluation value while moving the focus lens in the predetermined focal point detection range.
